(19) United States
(12) Patent Application Publication
(10) Pub. No.: US 2006/0012232 A1
(43) Pub. Date: Jan. 19, 2006

(54) Round recliner with sliding pin mechanism

(76) Inventors: Craig G. Coughlin, Shelby, MI (US); Christopher J. Ryan, Fraser, MI (US); Jacob P. Hellrung, Grosse Pointe Farms, MI (US)

Correspondence Address: HARNESS, DICKEY & PIERCE, P.L.C., P.O. BOX 828, BLOOMFIELD HILLS, MI, 48303, US

(21) Appl. No.: 11/183,234

(22) Filed: Jul. 15, 2005

Related U.S. Application Data
(60) Provisional application No. 60/588,373, filed on Jul. 15, 2004.
(60) Provisional application No. 60/651,406, filed on Feb. 9, 2005.

(51) Int. Cl. B60N 2/02

(52) U.S. Cl. 297/367

(57) ABSTRACT

A seat adjustment mechanism includes a recliner mechanism having a first recliner plate and a second recliner plate. The second recliner plate is rotatable relative to the first recliner plate about a first axis in an unlocked state and is fixed to the first recliner plate in a locked state. A locking plate is rotatable about the first axis and is fixed for rotation with the second recliner plate in a first state and rotatable relative to the second housing plate in a second state.

### CROSS-REFERENCE TO RELATED APPLICATIONS

This application claims the benefit of U.S. Provisional Application No. 60/588,373, filed on Jul. 15, 2004 and U.S. Provisional Application No. 60/651,406 filed on Feb. 9, 2005. The disclosures of the above applications are incorporated herein by reference.

### FlELD

The present teachings relate to seat adjustment mechanisms, and more particularly, to a recliner mechanism having an easy entry feature for use with a seat assembly.

### BACKGROUND

Reconfigurable seating systems are commonly used in vehicles to provide a comfortable seating arrangement and to improve access to various seating and/or cargo areas of the vehicle. For example, most vehicle seats include a recliner mechanism disposed generally between a seatback and a seat bottom to provide selective rotation of the seatback relative to the seat bottom. Rotation of the seatback relative to the seat bottom increases passenger comfort by providing a plurality of recline positions and improves access to the vehicle (i.e., behind the vehicle seat) for passenger entry and cargo loading.

The recliner mechanism is typically released by an actuation mechanism disposed near a junction of the seatback and seat bottom. The actuation mechanism may include a manually-operated or powered lever that manipulates internal components of the recliner mechanism to toggle the mechanism from a locked state to an unlocked state. When the lever is rotated, the recliner mechanism is toggled into the unlocked state and rotation of the seatback relative to the seat bottom is permitted.

In addition to providing a plurality of recline positions, conventional recliner mechanisms also allow the seatback to be positioned in a so-called “fold-flat” position such that the seatback is substantially parallel to the seat bottom. In the fold-flat position, the seatback provides a flat load floor and/or work surface and improves entry to an area generally behind the vehicle seat. When the desired position is achieved (i.e., either a reclined position or a fold-flat position), the actuation lever is released and the recliner mechanism is returned to the locked state. In the locked state, the recliner mechanism once again prevents rotation of the seatback relative to the seat bottom.

Conventional recliner mechanisms bias the seatback into a forward position such that when the recliner mechanism is actuated into the unlocked state, the seatback is rotated into the fold-flat position. Such actuation sufficiently moves the seatback into a parallel relationship with the seat bottom and therefore improves access to an area behind the vehicle seat. However, a user is typically required to bend down to actuate the recliner mechanism to rotate the seatback into the fold-flat position as the actuation handle is disposed proximate to the seat bottom. In addition, conventional recliner mechanisms do not typically include a memory function that returns the seatback to a desired angle relative to the seat bottom upon return to an upright position. Therefore a the user is inconvenienced by having to manipulate the seatback into a comfortable position each time the seatback is returned to an upright and usable position.

### SUMMARY

A seat adjustment mechanism includes a recliner mechanism having a first recliner plate and a second recliner plate. The second recliner plate is rotatable relative to the first recliner plate about a first axis in an unlocked state and is fixed to the first recliner plate in a locked state. A locking plate is rotatable about the first axis and is fixed for rotation with the second recliner plate in a first state and rotatable relative to the second housing plate in a second state.

Further areas of applicability of the present teachings will become apparent from the detailed description provided hereinafter. It should be understood that the detailed description and specific examples are intended for purposes of illustration only and are not intended to limit the scope of the teachings.

### BRIEF DESCRIPTION OF THE DRAWINGS

The present teachings will become more fully understood from the detailed description and the accompanying drawings, wherein:

FIG. 1 is a perspective view of a recliner assembly;

FIG. 2 is an exploded view of the recliner assembly of FIG. 1;

FIG. 3 is a side view of the recliner assembly of FIG. 1 in an upright and locked position;

FIG. 4 is a side view of the recliner assembly of FIG. 1 in a fold-flat position achieved through actuation of a recliner mechanism;

FIG. 5 is a side view of the recliner assembly of FIG. 1 in a fold-flat position through actuation of an easy-entry mechanism;

FIG. 6 is a side view of a seat assembly incorporating the recliner mechanism of FIG. 1; and

FIG. 7 is a side view of a seat assembly incorporating the recliner mechanism of FIG. 1 at an elevated pivot point to provide a table feature.

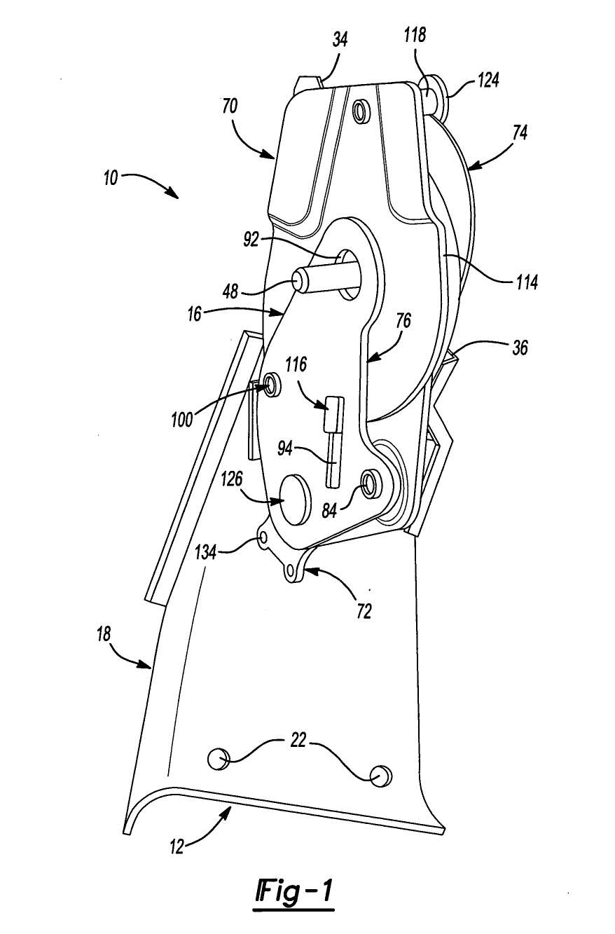

### DETAILED DESCRIPTION

The following description is merely exemplary in nature and is in no way intended to limit the teachings, application, or uses.

With reference to the figures, a seat adjustment mechanism 10 for use with a seat assembly is provided and includes a support plate 12, a recliner mechanism 14, and an easy-entry mechanism 16. The recliner mechanism 14 is supported by the support plate 12 and provides for recline or forward folding of a seatback relative to a seat bottom. The easy-entry mechanism 16 is supported by the recliner mechanism 14 and support plate 12 and provides for articulation of the seatback into a “fold-flat” position such that the seatback is folded into a parallel relationship relative to the seat bottom without having to manipulate the recliner mechanism 14.

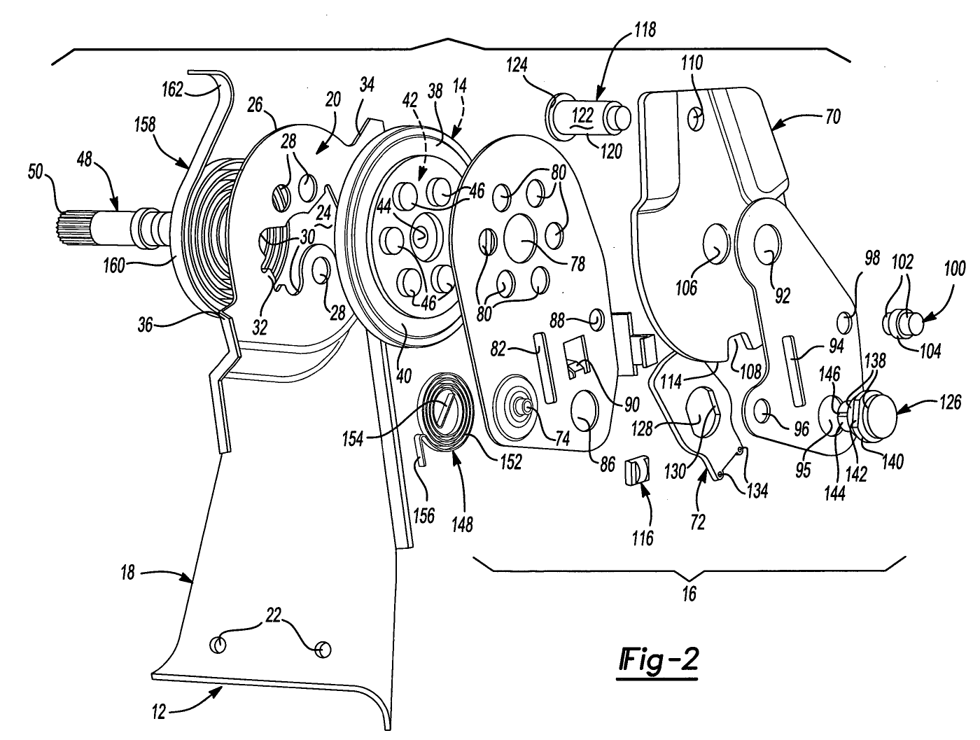

With reference to FIG. 2, the support plate 12 includes an attachment arm 18 and a mounting portion 20. The attachment arm 18 may include mounting apertures 22 for use in attaching the support plate 12 to an external structure such as seat assembly or other vehicle structure. The mounting portion 20 includes a main aperture 24, an arcuate top surface 26, and a series of apertures 28. The main aperture 24 includes three arcuate inner surfaces 30 having similar radii as apertures 28 and a spring post 32 extending therefrom. The arcuate top surface 26 extends between a first stop 34 and a second stop 36 and generally defines a range of motion for both the recliner mechanism 14 and the easy-entry mechanism 16.

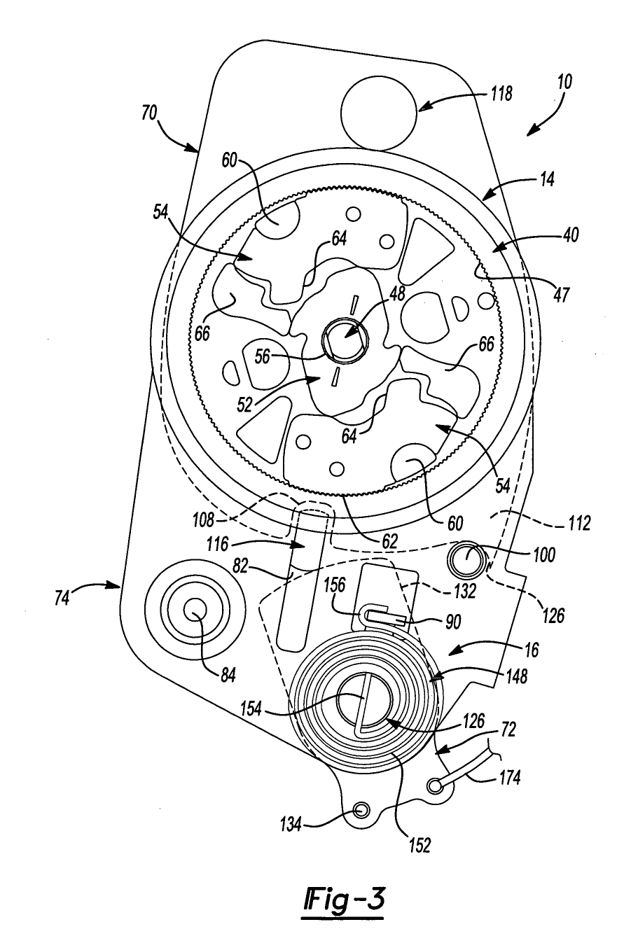

With reference to FIGS. 2 and 3, the recliner mechanism 14 includes an inner housing plate 38, an outer housing plate 40, and a locking mechanism 42. The inner housing plate 38 includes a series of projections (not shown) that are matingly received within apertures 28 of the support plate 12 and within arcuate inner surfaces 30 of the main aperture 24. Interaction between the apertures 28, arcuate surfaces 30, and projections fix the inner housing plate 38 to the support plate 12 and prevent relative movement therebetween.

The outer housing plate 40 is rotatably supported relative to the inner housing plate 38 and is selectively fixed to the inner housing plate 38 by the locking mechanism 42. The outer housing plate 40 includes an aperture 44 formed therethrough, a series of projections 46 radially spaced on an outer surface thereof, and a series of teeth 47 formed on an inner circumferential surface. The aperture 44 rotatably receives a spindle 48 having a series of teeth 50. The projections 46 are received by the easy-entry mechanism 16 to selectively fix the easy-entry mechanism 16 to the recliner mechanism 14.

The locking mechanism 42 is disposed generally between the inner and outer housing plates 38, 40 and includes a cam 52 and a pair of pawls 54. The cam 52 includes a central aperture 56 that is staked to the spindle 48 such that the cam 52 is fixed for rotation with the spindle 48. The pawls 54 are rotatably supported between the inner and outer housing plates 38, 40 and rotate about a pair of projections 60 formed integrally with the outer housing plate 40. Each pawl 54 includes a series of teeth 62 and an engagement surface 64. It should be understood that while the central aperture 56 is described as staked to the spindle 48 that any suitable process for fixedly attaching the cam 52 to the spindle 48 such as welding or broaching is anticipated and should be considered within the scope of the present teachings.

In operation, a rotational force is applied to the spindle 48 causing the cam 52 to rotate therewith. Rotation of the cam 52 causes engagement between the cam 52 and the engagement surface 64 of each pawl 54. Engagement between the cam 52 and engagement surfaces 64 causes each pawl 54 to rotate about a respective projection 60. Rotation of the pawls 54 about projections 60 continues until the pawls 54 are rotated into engagement with a pair of stops 66. Once sufficiently rotated by the cam 52, the teeth 64 of each pawl 54 disengage the teeth 47 of the outer housing plate 40 and the outer housing plate 40 is permitted to freely rotate relative to the inner housing plate 38 and support plate 12.

With reference to FIG. 2, the easy-entry mechanism 16 is shown to include a housing 68, a locking plate 70, and a cam 72. The housing 68 includes an inner housing plate 74 and an outer housing plate 76. The inner housing plate 74 includes a central aperture 78 rotatably receiving the spindle 48, a series of apertures 80 formed around the central aperture 78, and a slot 82. In addition, the inner housing plate 74 includes a projection 84, a pivot aperture 86, an attachment aperture 88, and a spring post 90.

The outer housing plate 76 includes a main aperture 92 rotatably receiving the spindle 48, a slot 94, a pivot aperture 95, and a pair of attachment apertures 96, 98. The outer housing plate 76 is fixedly attached to the inner housing plate 74 by inserting the projection 84 of the inner housing plate 74 into attachment aperture 96 and deforming the projection 84 (i.e., staking). A rivet 100 is inserted into attachment aperture 88 of the inner housing plate 74 and into aperture 98 of the outer housing plate 76 to further fix the outer housing plate 76 to the inner housing plate 74. Rivet 100 includes a pair of cylindrical sections 102 flanking a central cylindrical section 104. The cylindrical sections 102 are received within apertures 88, 98, respectively, while the central cylindrical section 104 is disposed generally between the inner and outer housing plates 74, 76 to define a space therebetween.

The locking plate 70 is rotatably supported between the inner and outer housing plates 74, 76 and includes a pivot aperture 106, a locking recess 108, an attachment aperture 110, and a stop arm 112. The pivot aperture 106 rotatably receives the spindle 48 and is rotatable about the spindle 48 relative to the inner and outer housing plates 74, 76. The locking recess 108 is formed in an arcuate surface 114 of the locking plate 70 and selectively receives a slide pin 116 to prevent rotation of the locking plate 70 relative to the inner and outer housing plates 74, 76. The slide pin 116 is slidably supported within slots 82, 94 of the inner and outer housing plates 74, 76 and is movable between a locked position and an unlocked position. The slide pin 116 is disposed generally within locking recess 108 in the locked position and is disengaged from the locking recess 108 in the unlocked position.

The attachment aperture 110 is disposed on an opposite side of the pivot aperture 106 from the locking recess 108 and fixedly receives a post 118. The post 118 includes a cylindrical body 120 having an engagement surface 122. One end of the post 118 is fixedly attached to attachment aperture 110 while the other end of the post 118 includes a flange 124. The stop arm 112 is disposed proximate to locking recess 108 and includes an engagement surface 126 that selectively engages rivet 100 to restrict rotation of the locking plate 70 relative to the inner and outer housing plates 74, 76.

The slide pin 116 is biased into engagement with the locking recess 108 of the locking plate 70 by the cam 72. The cam 72 includes a central aperture 128 having flats 130, an arcuate surface 132, and a pair of cable apertures 134. The cam 72 is rotatably supported between the inner and outer housing plates 74, 76 by a pivot 126.

The pivot 126 includes a pair of cylindrical sections 138 that are rotatably supported by apertures 86, 95 of the inner and outer housing plates 74, 76 and a central cylindrical section 140 having flats 142. The central aperture 128 of the cam 72 matingly receives the central cylindrical section 140 of the pivot 136 such that the flats 142 of the pivot 126 are aligned with the flats 130 of the cam 72. Engagement between flats 130 and flats 142 fixes the cam 72 for rotation with the pivot 126. The pivot 126 also includes an extension 144 having a spring slot 146 extending through the inner housing plate 74.

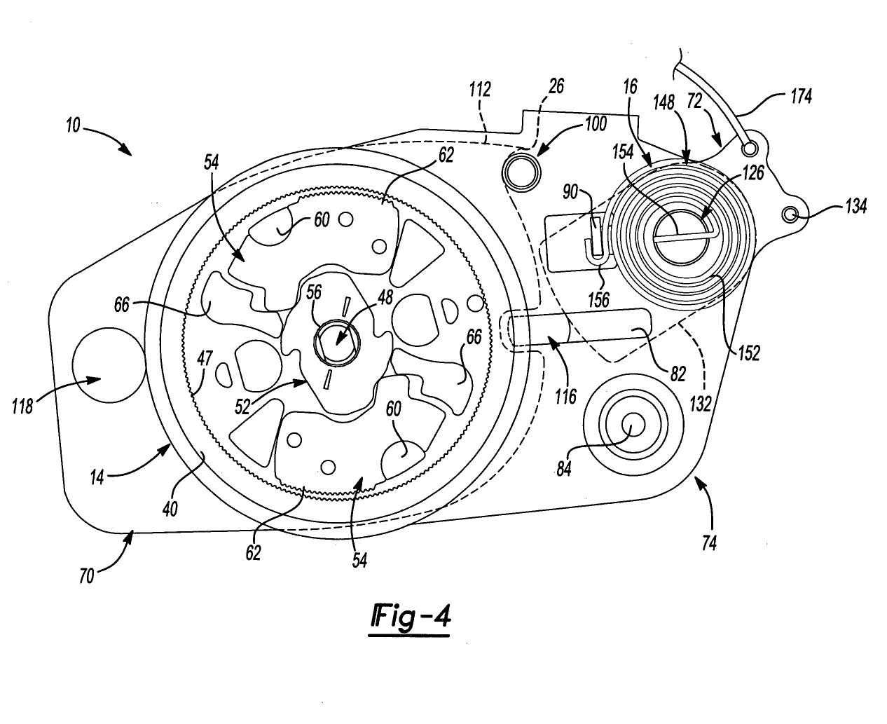

A coil spring 148 is disposed on an outer surface 150 of the inner housing plate 74 and includes a coiled main body 152, a centrally-disposed flat 154, and an extension 156. The centrally-disposed flat 154 is matingly received by the spring slot 146 of the pivot 126 while the extension 156 abuts the spring post 90 of the inner housing plate 74. The coiled main body 152, in conjunction with flat 154 and extension 156, cooperate to bias the pivot 136, and thus the cam 72, in the clockwise direction relative to the view shown in FIG. 4. In this manner, the cam 72 is biased into engagement with the slide pin 116 and causes the slide pin 116 to engage the locking recess 108 of the locking plate 70 to prevent rotation of the locking plate 70 relative to the inner and outer housing plates 74, 76.

With reference to FIGS. 3-5, operation of the seat adjustment mechanism 10 will be described in detail. In the use position, the recliner mechanism 14 is in a locked position such that the teeth 62 of the pawls 54 are in engagement with the teeth 47 of the outer housing plate 40. In this position, rotation of the outer housing plate 40 relative to the inner housing plate 38 is prohibited. In addition to the foregoing, the locking plate 70 is prevented from rotating independently of the recliner mechanism 14 and inner and outer housing plates 74, 76 due to the engagement between the slide pin 116 and the locking recess 108.

To adjust a position of the locking plate 70 relative to the attachment arm 18, a force is applied to the spindle 48 either by manually rotating the spindle 48 or through a powered operation. In either event, the rotational force causes the spindle 48 to rotate relative to the support plate 12 and rotate the cam 52 of the recliner mechanism 14. Rotation of cam 52 causes concurrent rotation of the pawls 54 about projections 60. Once the pawls 54 have been sufficiently rotated about projections 60, such that each pawl 54 is in contact with a stop 66, the teeth 62 of each pawl 54 are fully disengaged from the teeth 47 of the outer housing plate 40.

Once the teeth 62 of the pawls 54 are sufficiently disengaged from the outer housing plate 40, the outer housing plate 40 may be rotated relative to the inner housing plate 38 and support plate 12 (FIG. 3). Rotation of the outer housing plate 40 in the counterclockwise direction relative to the view shown in FIG. 4 is facilitated by a coil spring 158. Coil spring 158 includes a coiled main body 160 and an outwardly-extending arm 162. The coiled main body 160 is attached to the spring post 32 of the support plate 12 while the arm 162 is biased into engagement with the surface 122 of post 118. Therefore, when the pawls 54 are released from engagement with the teeth 47 of the outer housing plate 40, the outer housing plate 40, locking plate 70, and inner and outer housing plates 74, 76 are rotated in the counterclockwise direction relative to the view shown in FIG. 4 by the coil spring 158.

If rotation of the outer housing plate 40, locking plate 70, and inner and outer housing plates 74, 76 in the clockwise direction relative to the view shown in FIG. 4 is desired, a force must be applied to the outer housing plate 40, locking plate 70, and/or inner and outer housing plates 74, 76 against the bias of coil spring 158 to prevent rotation in the counterclockwise direction.

Once the desired rotational position of the outer housing plate 40, locking plate 70, and inner and outer housing plates 74, 76 is achieved, in either the clockwise or counterclockwise direction, the rotational force applied to the spindle 48 is released, and a pair of torsion springs (not shown) associated the recliner mechanism 14 bias the cam 52 in the clockwise direction relative to the view shown in FIG. 4. Sufficient rotation of the cam 52 causes rotation of the pawls 54 about projections 60 until the teeth 62 of each pawl 54 are meshed with teeth 47 of the outer housing plate 40. Once fully rotated, the position of the outer housing plate 40, locking plate 70, and inner and outer housing plates 74, 76 relative to the inner housing plate 38 and support plate 12 is fixed.

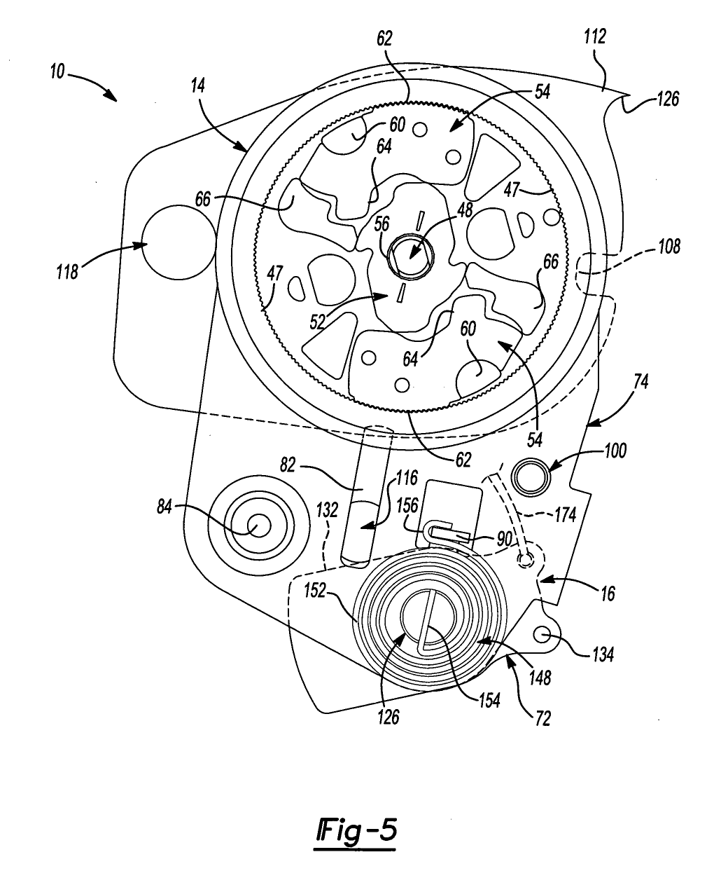

Independent rotation of the locking plate 70 relative to the recliner mechanism 14 and inner and outer housing plates 74, 76 is achieved through rotation of the cam 72 relative to the inner and outer housing plates 74, 76. Specifically, a rotational force is applied to the cam 72 generally at cable aperture 134. The force causes the cam 72 to rotate in the counterclockwise direction relative to the view shown in FIG. 5 and against the bias of coil spring 148. Sufficient rotation of the cam 72 releases engagement between the arcuate surface 132 of the cam 72 and the slide pin 116 and therefore allows the slide pin 116 to disengage the lock recess 108 of the locking plate 70. Once the slide pin 116 is disengaged from the locking recess 108, the locking plate 70 is permitted to rotate relative to the inner and outer housing plates 74, 76.

Once the slide pin 116 disengages the locking recess 108, the locking plate 70 is rotated in the counterclockwise direction relative to the view shown in FIG. 5 due to the interaction between coil spring 158 and post 118. The locking plate 70 is rotated relative to the recliner mechanism 14 and the inner and outer housing plates 74, 76 until the engagement surface 122 of post 118 contacts stop 36 of the support plate 12. At this point, further rotation of the locking plate 70 in the counterclockwise direction is prohibited.

To return the locking plate 70 to the use position, a force is applied to the locking plate 70 against the bias of coil spring 158 and the locking plate 70 is rotated about the spindle 48. Once the locking plate 70 has been sufficiently rotated such that the locking recess 108 is aligned with slots 82, 94, the slide pin 116 will traverse the slots 82, 94 and seat within the locking recess 108. The slide pin 1 16 traverses the slots 82, 94 due to the force applied thereto by the cam 72 under bias of coil spring 148.

Proper alignment of the locking plate 70 with the inner and outer housing plates 74, 76 is accomplished due to interaction between the stop arm 112 and rivet 100. Specifically, when the locking plate 70 is rotated in the clockwise direction relative to the inner and outer housing plates 74, 76, the slots 82, 94 are properly aligned with the slide pin 116 due to interaction between the stop arm 112 and the central cylindrical section 104 of rivet 100. The engagement of the stop arm 112 and rivet 100 prevents further rotation of the locking plate 70 in the clockwise direction and ensures that the slide pin 116 can engage the locking recess 108.

Once the slide pin 116 is disposed within the locking recess 108, the locking plate 70 is returned to the use position. It should be noted that the locking plate 70 is returned to the same angular position relative to the recliner mechanism 14 and the inner and outer housing plates 74, 76 that the locking plate 70 occupied prior to rotation of the cam 72 and release of the slide pin 116 from locking recess 108. This “memory” feature allows return of the locking plate 70 to the same angular position upon return to the use position. The memory feature is achieved by allowing rotation of the locking plate 70 relative to the recliner mechanism 14 and the inner and outer housing plates 74, 76 without changing the relative position of the pawls 54 relative the outer housing plate 40.

With particular reference to FIG. 6, the seat adjustment mechanism 10 is shown incorporated into a seat assembly 164 having a seatback 166 and a seat bottom 168. The seat adjustment mechanism 10 is disposed generally at a junction between the seatback 166 and seat bottom 168 to provide the seatback 166 with a plurality of recline positions relative to the seat bottom 168.

The seatback 166 is fixedly attached to the locking plate 70 and the seat bottom is fixedly attached to the support plate 12. In this manner, rotation of the locking plate 70 relative to the inner housing plate 38 causes concurrent rotation of the seatback 166 relative to the seat bottom 168. To rotate the seatback 166 relative to the seat bottom 168, a rotational force is applied to a handle 170 associated with the recliner mechanism 14. The handle 170 is matingly received by teeth 50 of the spindle 48 and therefore causes the spindle 48 to rotate when a rotational force is applied to the handle 170. Rotation of the spindle 48 causes the cam 52 of the recliner mechanism 14 to disengage each pawl 54 from the teeth 47 of the outer housing plate 40, as previously discussed. Once the pawls 54 are disengaged, the outer housing plate 40, locking plate 70, and inner and outer housing plates 74, 76 are free to rotate relative to the inner housing plate 38 and support plate 12.

Rotation of the locking plate 70 relative to the inner housing plate 38 causes concurrent rotation of the seatback 166 relative to the seat bottom 168. Once the desired position of the seatback 166 relative to the seat bottom 168 is achieved, the force applied to the handle 170 is released and the pawls 54 once again prevent rotation of the seatback 166 relative to the seat bottom 168.

FIG. 6 shows the range of motion of the seatback 166 relative to the seat bottom 168. The seatback 166 may be positioned in any number of angular positions relative to the seat bottom 168 through actuation of the recliner mechanism 14 as described above. A recline position “A” is shown in FIG. 6 relative to a design position “B.” It should be noted that while the seatback 166 is shown in a recline position relative to the design position B, that the seatback 166 may also be pivoted into a forward position relative to the design position B. For example, the seatback 166 may be rotated about the spindle 48 until the seatback 166 is substantially parallel with the seat bottom 168. This “fold-flat” position shown as position “C” provides a flat load floor and improves access to an area behind the seat assembly 164.

When the pawls 54 of the recliner mechanism 14 are engaged with the teeth 47 of the outer housing plate 40, rotation of the locking plate 70 may still be accomplished through use of the easy-entry mechanism 16. The easy-entry mechanism 16 includes a release handle 172 and cable 174 that cooperate to rotate the cam 72 and release the slide pin 116 from the recess 108.

The release handle 172 is disposed at an upper end of the seatback 166 to provide quick access to a user. The release handle 172 is rotatably supported by the seatback 166 and is coupled to one end of the cable 174. The other end of the cable 174 is fixedly attached to the cable aperture 134 of the cam 72 such that when the cable 174 is placed under tension due to rotation of the release handle 172, the cam 72 is similarly rotated.

Rotation of the cam 72 allows the slide pin 116 to disengage the locking recess 108 of the locking plate 70, as previously discussed. Once the slide pin 116 is fully disengaged from the locking recess 108, the locking plate 70 is rotated relative to the recliner mechanism 14 and inner and outer housing plates 74, 76, until the engagement surface 122 of post 118 engages stop 36 of the attachment arm 18. In this manner, the easy-entry mechanism 16 provides a user with the ability to quickly position the seatback 166 into the fold-flat position C without having to actuate the recliner mechanism 14.

To return the seatback 166 to a use position, a force is applied to the seatback 166 against the bias of coil spring 158 until the locking recess 108 is aligned with the slots 82, 94 and the stop arm 112 contacts rivet 100. Once the locking recess 108 is aligned with slots 82, 94 of the inner and outer housing plates 74, 76, the cam 72 is allowed to bias the slide pin 116 into the locking recess 108 and lock the position of the locking plate 70, and thus the seatback 166, relative to the seat bottom 168.

When the seatback 166 is rotated from the fold-flat position C, the seatback 166 is returned to the same angular position relative to the seat bottom 168 that the seatback 166 occupied prior to being articulated into the fold-flat position. When the easy-entry mechanism 16 is released, the recliner mechanism 14 remains locked (i.e., the pawls 54 remain engaged with the teeth 47 of the outer housing plate 40). Therefore, the relative position of the outer housing plate 40 and inner and outer housing plates 74, 76 relative to the inner housing plate 38 does not change. When the seatback 166 is returned to the upright position B, the slide pin 116 engages the locking recess 108 at the same angle as the relationship of the recliner mechanism to the inner and outer housing plates 74, 76 has not changed. Therefore the easy-entry mechanism 16 provides a “memory” feature that allows the user to articulate the seatback 166 into the fold-flat position and easily return the seatback 166 to a desired angular position relative to the seat bottom 168 without having to adjust the recliner mechanism 14.

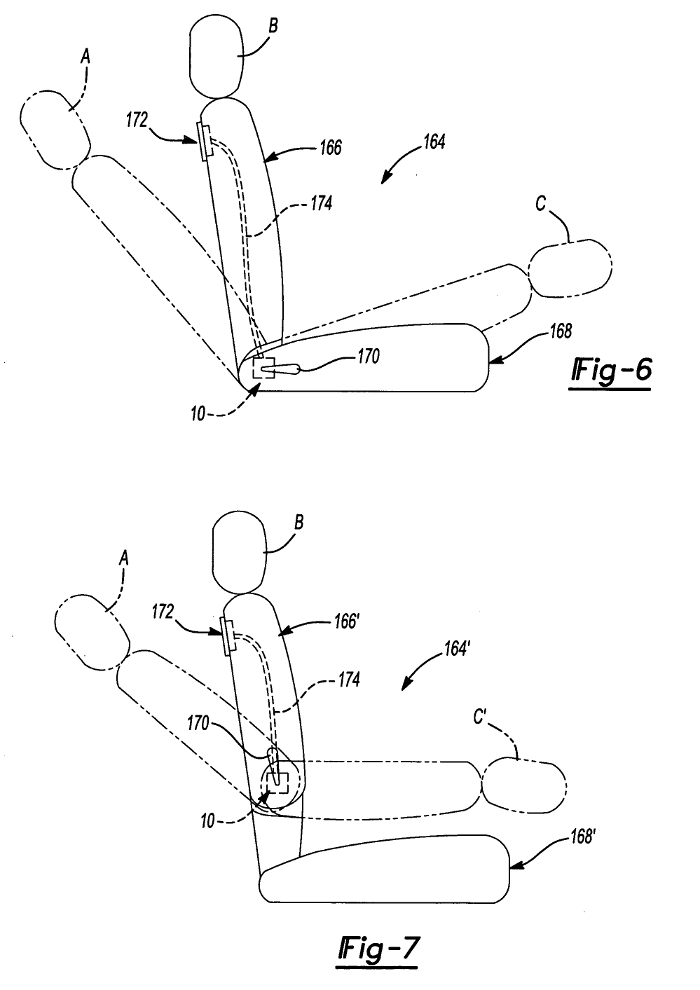

FIG. 7 shows the seat adjustment mechanism 10 incorporated into a seat assembly 164′. The seat assembly 164′ is similar to the seat assembly 164, however, the pivot point of the seatback 166′ relative to the seat bottom 168′ is higher that the pivot point of the seatback 166 relative to the seat bottom 168.

Seat assembly 164′ includes a seatback 166′ and a seat bottom 168′. The seatback 166′ is pivotably supported by an extension 174 of the seat bottom 168′ such that the pivot point of the seatback 166′ is positioned at a higher location on the seatback 166′ when compared to the position of the pivot point of the seatback 166. The design position B of the seatback 166′ and angular position A of the seatback 166′ do not change. The seatback 166′ simply pivots at a higher location as compared to the seatback 166 of seat assembly 164. When the seatback 166′ is adjusted into a fold-flat position C′, such that the seatback 166′ is substantially parallel to the seat bottom 168′, a gap 176 is created generally between the seatback 166′ and the seat bottom 168′.

The gap 176 is created due to the higher pivot point of the seatback 166′ and therefore results in a higher load floor (i.e., back of seatback 166′ when folded flat) when compared to seatback 166. The higher load floor allows the seatback 166′ to be used as a table when the in the fold-flat position. As with seat assembly 164, the seatback 166′ may be articulated into the fold-flat position through either actuation of the recliner mechanism 14 or through actuation of the easy-entry mechanism 16.

As described, the seat adjustment mechanism 10 provides the ability to position a seatback 166,166′ in any number of angular positions relative to a seat bottom 168′ through actuation of a recliner mechanism 14. In addition, the seat adjustment mechanism 10 provides the ability to position the seatback 166, 166′ in a fold-flat position relative to the seat bottom 168, 168′ through actuation of either the recliner mechanism 14 or the easy-entry mechanism 16 and allows the seatback 166,168′ to be used as a table by adjusting the location of the pivot point of the seatback 166, 166′. Furthermore, the easy-entry mechanism 16 provides a memory feature that allows the seatback 166,166′ to be automatically returned to a desired angular position relative to the seat bottom 168, 168′ from the fold-flat position.

The description of the teachings is merely exemplary in nature and, thus, variations that do not depart from the gist of the teachings are intended to be within the scope of the invention. Such variations are not to be regarded as a departure from the spirit and scope of the invention.

What is claimed is:

1. A seat adjustment mechanism comprising:
a recliner mechanism having a first recliner plate and a second recliner plate, said second recliner plate rotatable relative to said first recliner plate about a first axis in an unlocked state and fixed to said first recliner plate in a locked state; and
a locking plate rotatable about said first axis, said locking plate fixed for rotation with said second recliner plate in a first state and rotatable relative to said second housing plate in a second state.

2. The seat adjustment mechanism of claim 1, further comprising a locking mechanism operable to actuate said locking plate between said first state and said second state.

3. The seat adjustment mechanism of claim 2, wherein said locking mechanism includes a cam, a biasing member, and a pin slidably supported relative to said locking plate.

4. The seat adjustment mechanism of claim 3, wherein said locking plate includes a recess, said recess receiving said pin in said first state to prevent rotation of said locking plate relative to said second housing plate and separated from said recess in said second state to permit rotation of said locking plate relative to said housing plate.

5. The seat adjustment mechanism of claim 4, wherein said biasing member is a coil spring, said coil spring operable to bias said pin into said recess through rotation of said cam.

6. The seat adjustment mechanism of claim 1, wherein said recliner mechanism is a round recliner mechanism.

7. The seat adjustment mechanism of claim 1, further comprising an actuation pivot operable to actuate said recliner mechanism between said locked state and said unlocked state.

8. The seat adjustment mechanism of claim 1, further comprising a biasing member acting on said locking plate to bias said locking plate in a first rotational direction.

9. A seat adjustment mechanism comprising:
a recliner mechanism having a first recliner plate and a second recliner plate, said second recliner plate rotatable relative to said first recliner plate in an unlocked state and fixed to said first recliner plate in a locked state;
a housing assembly having a first housing plate fixedly attached to said second recliner plate and a second housing plate fixedly attached to, and separated from, said first housing plate; and
a locking plate rotatably supported between said first housing plate and said second housing plate, said locking plate fixed for rotation with said second recliner plate and said first and second housing plates in a first state and rotatable relative to said second recliner plate and said first and second housing plates in a second state.

10. The seat adjustment mechanism of claim 9, further comprising a locking mechanism disposed between said first housing plate and said second housing plate.

11. The seat adjustment mechanism of claim 10, wherein said locking mechanism includes a cam, a biasing member, and a pin slidably supported between said first housing plate and said second housing plate.

12. The seat adjustment mechanism of claim 11, wherein said pin is disposed within a recess of said locking plate in said first state and removed from said recess in said second state.

13. The seat adjustment mechanism of claim 12, wherein said biasing member is a coil spring, said coil spring operable to bias said pin into said recess through rotation of said cam.

14. The seat adjustment mechanism of claim 9, wherein said recliner mechanism is a round recliner mechanism.

15. The seat adjustment mechanism of claim 9, further comprising an actuation pivot operable to actuate said recliner mechanism between said locked state and said unlocked state.

16. The seat adjustment mechanism of claim 9, further comprising a biasing member acting on said locking plate to bias said locking plate in a first rotational direction.

17. A seat assembly comprising:
a seat bottom;
a seatback pivotably supported by said seat bottom;
a seat adjustment mechanism operable to selectively restrict rotation of said seatback relative to said seat bottom, said seat adjustment mechanism comprising:
a recliner mechanism having a first recliner plate and a second recliner plate, said second recliner plate rotatable relative to said first recliner plate about a first axis in an unlocked state to rotate said seatback relative to said seat bottom and fixed to said first recliner plate in a locked state to prevent rotation of said seatback relative to said seat bottom; and
a locking plate attached to said seatback and rotatable about said first axis, said locking plate fixed for rotation with said second recliner plate in a first state and rotatable relative to said second housing plate in a second state.

18. The seat assembly of claim 17, further comprising a locking mechanism operable to actuate said locking plate between said first state and said second state.

19. The seat assembly of claim 18, wherein said locking mechanism includes a cam, a biasing member, and a pin slidably supported relative to said locking plate.

20. The seat assembly of claim 17, wherein said recliner mechanism is a round recliner mechanism.
